(19) United States
(12) Patent Application Publication
(10) Pub. No.: US 2015/0143849 A1
(43) Pub. Date: May 28, 2015

(54) METHOD AND SYSTEM OF LASER CUTTING A SHEET MATERIAL

(71) Applicant: Corning Incorporated, Corning, NY (US)

(72) Inventors: Kun Hung Tu, Tainan City (TW); Craig Steven Weber, Erin, NY (US)

(21) Appl. No.: 14/539,460

(22) Filed: Nov. 12, 2014

Related U.S. Application Data
(60) Provisional application No. 61/908,989, filed on Nov. 26, 2013.

(51) Int. Cl. C03B 33/09

(52) U.S. Cl. CPC C03B 33/091
USPC 65/112

(57) ABSTRACT

A method of cutting a sheet material includes mounting the sheet material on a support and forming a porous barrier between the sheet material and the support by interposing at least one sheet of porous material between the sheet material and the support. The method includes focusing a laser beam at a target point relative to the sheet material on the support. A relative motion is effected between the focused laser beam and the sheet material such that the focused laser beam moves along a predetermined path on the sheet material to cut the sheet material along the predetermined path while the porous barrier shields the support from damage by the focused baser beam.

### CROSS-REFERENCE TO RELATED APPLICATIONS

This application claims the benefit of priority under 35 U.S.C. §119 of U.S. Provisional Application Ser. No. 61/908989 filed on Nov. 26, 2013 the contents of which are relied upon and incorporated herein by reference in their entirety.

### FIELD

The field relates to laser cutting of sheet materials, especially those comprising ion-exchanged glass.

### BACKGROUND

Ion-exchanged glass is widely used in the commercial electronics industry as cover glass for cell phones, handheld tablet size devices, and other devices with touch functionality. Wide use of ion-exchanged glass in this industry is due to the high scratch resistance and overall durability of the glass, which comes from the ion-exchange process. Ion-exchanged glass has compressive stress on its surface and tensile stress on its interior. When force is applied to the ion-exchanged glass, any tension induced near the glass surface will be reduced by the surface compression stress. Thus greater force will be needed to break the ion-exchanged glass compared to a glass that has not been strengthened by ion-exchange.

There are two main methods for producing a cover glass with touch functionality, also known as a touch panel. The first and more conventional method is a discrete approach and involves cutting individual glass pieces from a large glass sheet that has not been chemically strengthened. Each individual glass piece is finished to the required device size and then strengthened by ion-exchange. A separate sensor glass sheet (or film) having the touch function applied on it is cut into device sizes. Each sensor glass piece is then laminated to a finished glass piece having the same device size to create a touch panel.

The second method for producing a touch panel is referred to as One Glass Solution (OGS). In this method, the touch function is applied directly to a large glass sheet, effectively forming an array of touch panels on a single sheet. The single sheet with the array of touch panels is then cut into individual touch panels with the required device size. This method requires strengthening the large glass sheet by ion-exchange prior to applying the touch function and any decorative printing on the glass sheet and prior to cutting the resulting single sheet with the array of touch panels into individual touch panels. The OGS approach enables manufacturers to produce a thinner and lighter touch panel with fewer process steps at a lower cost compared to the discrete approach.

The OGS approach requires cutting of a large glass sheet that has been strengthened by ion-exchange or by other means. Common methods used to cut large glass sheets are mechanical scribe and break and CO₂ laser cutting processes. The presence of the toughened layers of the strengthened glass makes conventional mechanical and CO₂ laser cutting of the strengthened glass difficult. It is particularly difficult to cut chemically strengthened glass with high central tension using these methods. To explain this further, the mechanical scribe and break process uses a cutting wheel that is traversed over the glass sheet with an applied force. The force applied to the cutting wheel must be great enough to create a vent or median crack that effectively penetrates the compressive depth layer in order to enable separation. Due to the high central tension (CT) of the glass, especially with CT>45 MPa, the median crack often propagates uncontrollably, resulting in low process yields. A similar problem exists with CO₂ laser processes. The thermal heating and cooling used in the CO₂ cutting process results in crack formation that is not well controlled. The high central tension in ion-exchanged glass results in very narrow or non-existent process windows for both the mechanical scribe and break and CO₂ laser processes.

### SUMMARY OF INVENTION

Green lasers operating at short visible wavelengths have been used as an alternative to CO₂ laser in cutting of ion-exchanged glass. A typical green laser cutting process involves mounting the ion-exchanged glass in a metal chuck and then applying the laser to the glass to cut the glass. It was found that the green light needed to interact with the material of the chuck to efficiently initiate the laser cutting process due to the glass having a low absorption of the green light. This interaction between the green laser and chuck created damage to the chuck, rendering the chuck an item that needs to be serviced or replaced periodically.

Nanosecond lasers operating at ultraviolet (UV) wavelengths have been used to cut ion-exchanged glass. In this case, the UV light did not need to interact with the material of the chuck to efficiently initiate the laser cutting process due to the glass having a higher absorption of the UV light, i.e., compared to the green light. In fact, cutting the glass while the glass was in contact with the chuck created a higher degree of edge chipping in the pieces cut from the glass than was desired.

In the green and nanosecond UV laser cutting processes mentioned above, the laser beam traveled through the glass and was focused below the bottom surface of the glass. This precipitated the concept of using a carrier plate with milled channels, where the laser scribes in the glass would occur over a channel milled into the carrier plate. The advantages of this approach were that the carrier plate was not damaged by the laser and the as-cut product edge finish improved.

However, each unique device size requires a unique carrier plate with channels milled into the plate corresponding to the laser scribe paths. Although a carrier plate can be modified to potentially accept multiple devices, this adds a level of cost and complexity to the process, not to mention the lead time required to have the carrier plates manufactured or modified.

The subject matter disclosed herein relates to a method of protecting a support while cutting a sheet material mounted on the support using a laser beam. This method can be used with ion-exchanged materials, even those with high central tension. The method allows the support to be protected from laser damage while minimizing chips on the surfaces of the material that is being cut by the laser.

In one illustrative embodiment, a method of cutting a sheet material includes mounting the sheet material on a support. A porous barrier is formed between the sheet material and the support by interposing at least one sheet of porous material between the sheet material and the support. The method includes focusing a laser beam at a target point relative to the sheet material. The method further includes effecting a relative motion between the focused laser beam and the sheet material such that the focused laser beam moves along a predetermined path on the sheet material to cut the sheet material along the predetermined path while the porous barrier shields the support from damage by the focused laser beam.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a system for cutting a sheet material using a laser beam.

FIG. 2 shows a definition of Z-focus of a laser beam.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements.

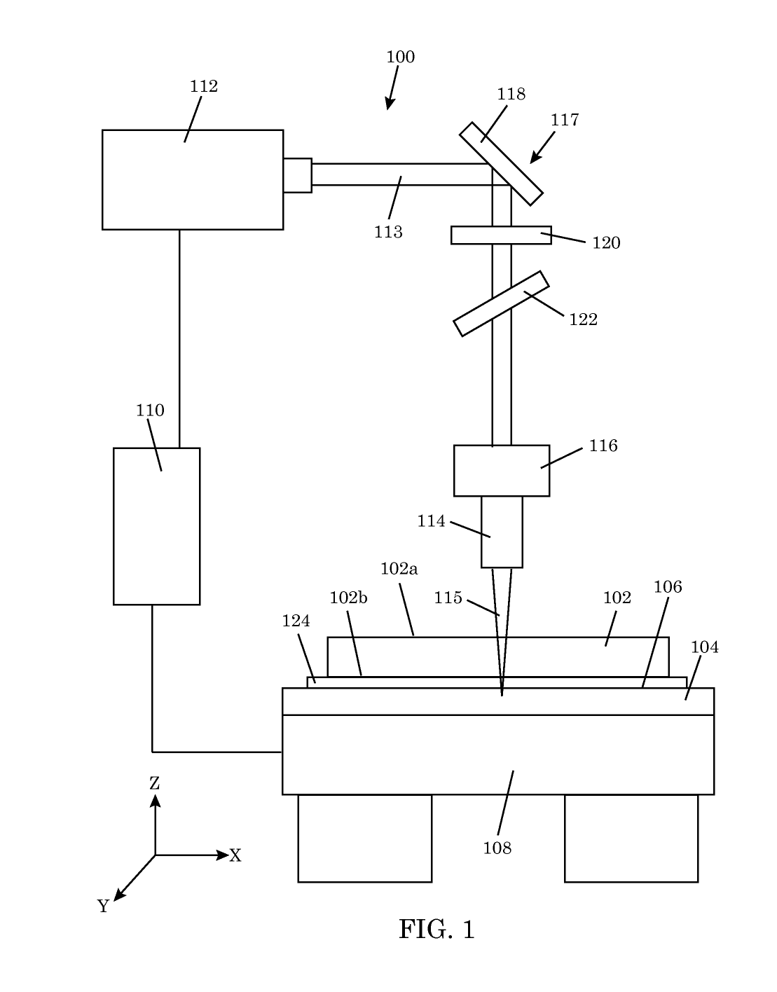

FIG. 1 shows an illustrative system 100 for cutting a sheet material 102 using a laser beam. The sheet material 102 may be made of a single layer of material or made of multiple layers of different materials. In one embodiment, the sheet material 102 is selected from a glass sheet, a glass-ceramic sheet, an ion-exchanged glass sheet, an ion-exchanged glass-ceramic sheet, and a touch panel. In one embodiment, the touch panel includes a layer of sensor material on a glass or glass-ceramic sheet or an ion-exchanged glass or glass-ceramic sheet. The touch panel may be formed through ITO sensor deposition on the glass or glass-ceramic sheet or on ion-exchanged glass or glass-ceramic sheet. In general, the sheet material 102 may be made of one or more large band-gap and/or transparent materials, such as crystals, semiconductors, glasses, ceramics, organics, and plastics. The sheet material 102 typically has a thickness in a range from 0.4 nun to 1.1 mm, although a thickness outside of this range is possible.

The system 100 includes a support 104 having a flat surface 106 on which the sheet material 102 is mounted. The support 104 may be made of metal or other suitable support material, such as alumina or silicon carbide. The support 104 may be in the form of a plate or other structure with a flat surface on which the sheet material 102 can be mounted. In one embodiment, the support 104 is mounted on a motion device 108, which may include one or more translation stages (not identified separately). The motion device 108 may be operated to provide translational motion to the support 104, and thereby the sheet material 102, along one or more of the X-axis, the Y-axis, and the Z-axis. The motion device 108 may be operated manually or may receive commands from a control system 110. Where used, the control system 110 includes the necessary processing circuitry to communicate with the translation stage(s) in the motion device 108 as needed. The support 104 may also be an integral part of the motion device 108 such that a flat surface of the motion device 108 provides the flat surface 106 on which the sheet material 102 is mounted.

A laser device 112 is mounted above the support 104 and operable to provide a laser beam 113 for cutting the sheet material 102. The laser device 112 may receive commands about output laser energy from the control system 110. In one embodiment, the laser device 112 is a short pulsed laser device capable of generating laser pulses with duration in the nanosecond regime. This laser device may also be referred to as a nanosecond laser. In one illustrative embodiment, the operating frequency of the nanosecond laser is in a range from approximately 40 KHz to 150 KHz. In one embodiment, the short pulsed laser device generates pulses at wavelengths in the ultraviolet range. Pulse repetition rates may be in a range from 1 Hz to 10 MHz. In one illustrative embodiment, the pulse repetition rate is in a range from 80 KHz to 100 KHz, and more particularly around 90 KHz. In other embodiments, the laser device 112 may be a continuous wave laser, e.g., CO₂ laser, or long pulsed laser, although these lasers tend not to be as efficient as the short pulsed laser in processing large band-gap and transparent materials. Other laser devices such as green laser and infrared laser devices may be used in other embodiments. In general, the laser device and operating wavelength should be selected based on the properties of the sheet material to be cut. The nanosecond UV laser is appropriate for cutting a sheet material containing ion-exchanged glass or glass-ceramic.

The system 100 includes a focusing lens 114 for creating a focused laser beam 115 from the output of the laser device 112. The focusing lens 114 is supported in a lens holder 116 positioned above the support 104. The height of the focusing lens 114 above the sheet material 102 can be adjusted, e.g., by operating the motion device 108 to move the support 104 along the Z-axis or by moving the lens holder 116 along the Z-axis using a translation mechanism (not shown) coupled to the lens holder 116. The focal point of the focused laser beam 115, as determined by the height of the focusing lens 114 above the sheet material 102, may be above or at the top surface 102a of the sheet material, inside the sheet material 102, or at or below the bottom surface 102b of the sheet material. An optical module 117 may be provided to align the laser beam 113 generated by the laser device 112 with the focusing lens 114. The optical module 117 includes, in one embodiment, a beam reflector 118, a half-wavelength wave-plate 120, and a beam splitter 122.

In one embodiment, a porous barrier 124 is formed between the bottom surface 102b of the sheet material 102 and the top surface 106 of the support 104. The porous barrier 124 is formed by applying one or more sheets of porous material on the top surface 106 and then placing the sheet material 102 on the sheet(s) of porous material, where the sheet(s) of porous material act as the porous barrier 124. It is also possible to apply the one or more sheets of porous material to the bottom surface 102b of the sheet material 102 prior to mounting the sheet material 102 on the support 104. The porous barrier 124 will prevent damage lines from being scribed into the top surface 106 of the support 104 by the focused laser beam 115. By preventing damage lines from being scribed into the top surface 106, contamination of the sheet material 102 by the material of the support 104 will be avoided. Also, the need to periodically service or replace the support 104 will be avoided. The porous barrier 124 will also shield the sheet material 102 from direct contact with the support surface 104, thereby reducing the potential for scratching the bottom surface 102b of the sheet material 102.

In one illustrative embodiment, the porous barrier 124 has a fibrous or cross-linked pore structure to avoid a direct line of sight between the laser beam and the top surface 106 of the support 104. A sheet of porous paper that allows air to be drawn through it, much like a filter, has been found to be an effective porous barrier for the purposes described above. One or more such sheets can be used in the porous barrier 124. Color printing paper, interleaf paper, filter paper, vacuum paper, and the like are examples of papers that could be used to form the porous barrier 124. One suitable porous paper is available as Interleaving Paper from Yuen Foong Yu Paper MFg. Co. Ltd, Taiwan, R.O.C. Papers having paper density or weight in a range from 20 g/m² to 130 g/m² are examples of papers that could be used as the porous material in the porous barrier 124. Paper can burn under intense laser power. In the method of cutting described herein, the laser scribe speed is typically very fast such that intense laser power does not dwell over any particular spot of the porous paper for too long as to result in burning of the paper at the spot. For added safety, a porous paper that is flame-resistant may be selected for use in the porous barrier 124. In alternate embodiments, fibrous materials besides porous paper may be used as the porous barrier 124. The thickness of the porous barrier 124 is typically in a range from 60 μm to 80 μm, although a thickness outside of this range is possible, e.g., a thickness greater than 80 μm may be used.

In one embodiment, a method of cutting the sheet material 102 includes operating the laser device 112 to generate a pulsed laser beam and focusing the pulsed laser beam on the sheet material 102 while the sheet material 102 is mounted on the support 104 but separated from direct contact with the support 104 by the porous barrier 124. The method includes focusing the pulsed laser beam, e.g., using the focusing lens 114, to some target point relative to the sheet material 102. The pulsed laser beam may be focused into a round beam or an elongated beam, e.g., an elliptical beam. In the case of the elongated beam, the long side of the beam is aligned with the cutting path. The spot size of the focused beam at the focal plane can be suitably selected to achieve the desired scribe line. The diameter of the focused beam (or width of the focused beam in the case of an elongated beam) at the focal plane may be in a range from 4 μm to 40 μm, for example. For the elongated beam, the aspect ratio of the focused beam at the focal plane may be greater than 1.5, for example. The energy density at the focal point of the pulsed laser beam should be at least equal to the minimum energy density required to ablate the sheet material 102. This minimum energy density is dependent on what the sheet material 102 is made of and the duration of the laser pulse.

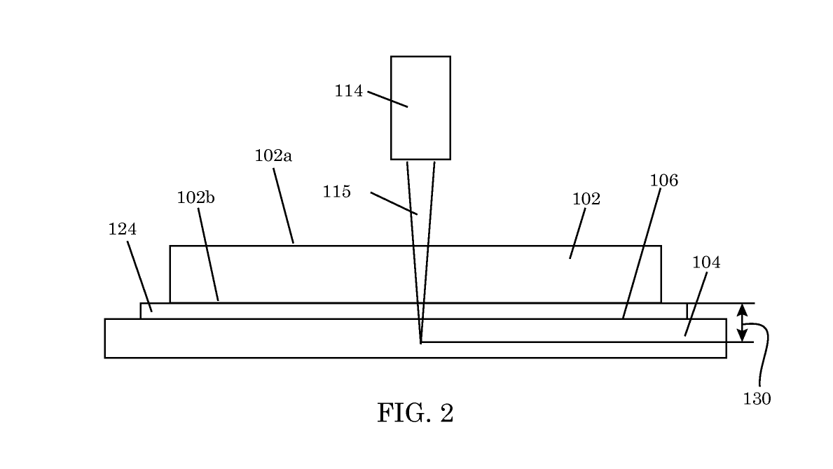

The laser cutting parameter Z-focus, as shown at 130 in FIG. 2, is the distance between the focal plane of the laser beam 115 and the bottom surface 102b of the sheet material 102. For good separation (cutting through) of the sheet material 102, the damage caused by the laser beam 115 should extend to the bottom surface 102b of the sheet material 102. If the Z-focus is too high, damage will be confined within the sheet material 102, resulting in slow separation and possible fractures. If the Z-focus is too low, large bottom chipping will occur. Preferably, for cutting through the sheet material 102, the Z-focus is placed below the bottom surface 102b of the sheet material 102, but not too low as to result in large bottom chipping on the sheet material 102. Optimal placement of the focal point of the laser beam 115 below the sheet material 102 can be determined experimentally.

Cuts are made in the sheet material 102 by moving the focused laser beam 115 across the sheet material 102 along predetermined paths. The moving of the laser beam may be achieved by translating the sheet material 102 relative to the laser beam, e.g., using the motion device 108, or by translating the laser beam relative to the sheet material 102 using a motion system (not shown) coupled to the laser device 112, optical module 117, and lens holder 116.

The focused laser beam 115 moves across the sheet material 102 along predetermined paths to cut the sheet material 102 into a plurality of individual pieces. Each cut along a predetermined path may be achieved in one step or in multiple steps. If cutting in multiple steps, instead of cutting through the sheet material 102 all at once, the focal point of the laser beam may be set such that a cut having a depth smaller than the thickness of the sheet material 102 is first made. Then, the focal point of the laser beam can be adjusted such that the cut can be deepened. This process can continue until the sheet material 102 is cut through. In one embodiment, the sheet material 102 is cut along the predetermined paths by means of the damage created in the sheet material 102 by the laser energy alone. In other embodiments, a coolant may be applied along scribe lines created in the sheet material 102 by the laser beam to effect complete separation of the sheet material 102 at the scribe lines.

With the use of the porous barrier 124 as described above, cutting of the sheet material 102 can be achieved without damage to the support 104. With proper control of the laser cutting parameters, it is expected that laser cutting yield in excess of 98% with edge chipping on both the top and bottom surfaces of the sheet material of less than 100 μm can be achieved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of cutting a sheet material, comprising;
mounting the sheet material on a support;
forming a porous barrier between the sheet material and the support by interposing at least one sheet of porous material between the sheet material and the support;
focusing a laser beam at a target point relative to the sheet material on the support; and
effecting a relative motion between the focused laser beam and the sheet material such that the focused laser beam moves along a predetermined path on the sheet material to cut the sheet material along the predetermined path while the porous barrier shields the support from damage by the focused laser beam.

2. The method of claim 1, wherein the at least one sheet of porous material comprises a sheet of porous paper.

3. The method of claim 1, wherein the porous barrier has a fibrous or cross-linked pore structure.

4. The method of claim 1, wherein focusing the laser beam comprises focusing the laser beam below a surface of the sheet material nearest to the porous barrier.

5. The method of claim 1, wherein the sheet material is selected from the group consisting of a glass sheet, a glass-ceramic sheet, an ion-exchanged glass sheet, an ion-exchanged glass-ceramic sheet, and a touch panel.

6. The method of claim 1, wherein the laser beam is a pulsed laser beam having a wavelength in an ultraviolet range.

7. The method of claim 1, wherein the laser beam is a pulsed laser beam having a pulse duration in a nanosecond regime.

8. A system for cutting a sheet material, comprising:
a laser device for providing a laser beam;
a support on which the sheet material is mounted;
at least one sheet of porous material for interposing between the support and sheet material to form a porous barrier between the support and the sheet material; and
a mechanism for effecting a relative motion of the laser beam with respect to the support such that the laser beam moves along a predetermined path on the sheet material when the sheet material is mounted on the support.

9. The system of claim 8, wherein the at least one sheet of porous material comprises a sheet of porous paper.

10. The system of claim 8, wherein the porous barrier formed by the at least one sheet of porous material has a fibrous or cross-linked pore structure.

11. The system of claim 8, further comprising a focusing lens for focusing the laser beam at a target point relative to the sheet material on the support.
